(19) United States
(12) Patent Application Publication
(10) Pub. No.: US 2018/0055003 A1
(43) Pub. Date: Mar. 1, 2018

(54) Pet Crawl-In Den

(71) Applicant: Roger Norde, Fayetteville, GA (US)

(72) Inventor: Roger Norde, Fayetteville, GA (US)

(21) Appl. No.: 15/251,170

(22) Filed: Aug. 30, 2016

(51) Int. Cl. A01K 1/03; A01K 1/035

(52) U.S. Cl. CPC A01K 1/033; A01K 1/0353

(57) ABSTRACT

A pet crawl-in den including a waterproof igloo shelter body having an annular housing with an aperture through each of a front side and a rear side thereof and a hollow cylindrical access member perpendicularly disposed on each of the front and rear sides in direct alignment with a respective aperture to provide pet entry and exit routes. A lid, preferably a dome, is hingedly disposed atop the top edge of the annular housing and has a lower edge alignable with an entire top edge of the housing and is latchable to the housing. Disc-shaped footing bodies with a gripping surface on a bottom surface of the housing prevent the housing from sliding across a slick surface. A washable disc-shaped cushioned bed is removably disposed within the annular housing for the comfort of a pet resting within the annular housing.

### BACKGROUND OF THE INVENTION

Various types of pet beds and pet shelters are known in the prior art. These known pet beds and pet shelters often have a permeable bottom side, which allows the bed or shelter to become soaked with rain water or spilled water, are often not enclosed enough to protect the interior thereof from negative weather conditions, such as rain and snow, and do not have an entry and separate exit, thus allowing a pet to become entrapped within the interior. In addition, cleaning known pet beds and pet shelters has been a problem when a pet bed is formed of non-washable materials or is attached directly to the pet shelter. Indoor pets often sleep or rest on a chair, a bed, or another location within a house on where pet occupation is undesirable. The present pet crawl-in den addesses the foregoing issues by providing an igloo shelter body including an annular housing, a pair of cylindrical access members on opposite sides of the housing from each other, a latchable lid disposed atop the annular housing, and a plurality of footing bodies disposed on a bottom surfaceof the annular housing to permit the igloo shelter body to be separated from the ground surface on which the igloo shelter body is placed.

### FIELD OF THE INVENTION

The present invention relates to pet products, and more particularly, to a pet crawl-in den.

### SUMMARY OF THE INVENTION

The general purpose of the present pet crawl-in den, described subsequently in greater detail, is to provide a pet crawl-in den which has many novel features that result in a pet crawl-in den which is not anticipated, rendered obvious, suggested, or even implied by prior art, either alone or in combination thereof.

To accomplish this, the present pet crawl-in den includes a waterproof igloo shelter body having an annular housing. An aperture is disposed through each of a front side and a rear side of the housing. The igloo shelter body also includes a pair of hollow cylindrical access members. One of the access members is perpendicularly disposed on each of the front side and the rear side in direct alignment with a respective one of the apertures. Each of the access members has a conduit in fluid communication with the respective aperture. The pair of access members provides a pet, such as a cat or a dog, not only entry and exit route from either the front side or the rear side, but also an escape route if attacked or in the event of a fire through either the front side or the rear side.

A lid, preferably a dome, is hingedly disposed atop the top edge of the annular housing. A plurality of disc-shaped footing bodies, each having a gripping surface, is disposed on the bottom surface of the annular housing. to prevent the housing from sliding across a slick surface. A washable disc-shaped cushioned bed is removably disposed within the annular housing for the comfort of a pet resting within the annular housing. Each of the aperture and the conduit of each of the access members has a same diameter which is in a range of six inches to forty-eight inches to accommodate entry and exit of pets in a wide range of sizes. The present device is provided for both indoor and outdoor use.

Thus has been broadly outlined the more important features of the present pet crawl-in den so that the detailed description thereof that follows may be better understood and in order that the present contribution to the art may be better appreciated.

### BRIEF DESCRIPTION OF THE DRAWINGS

### FIGURES

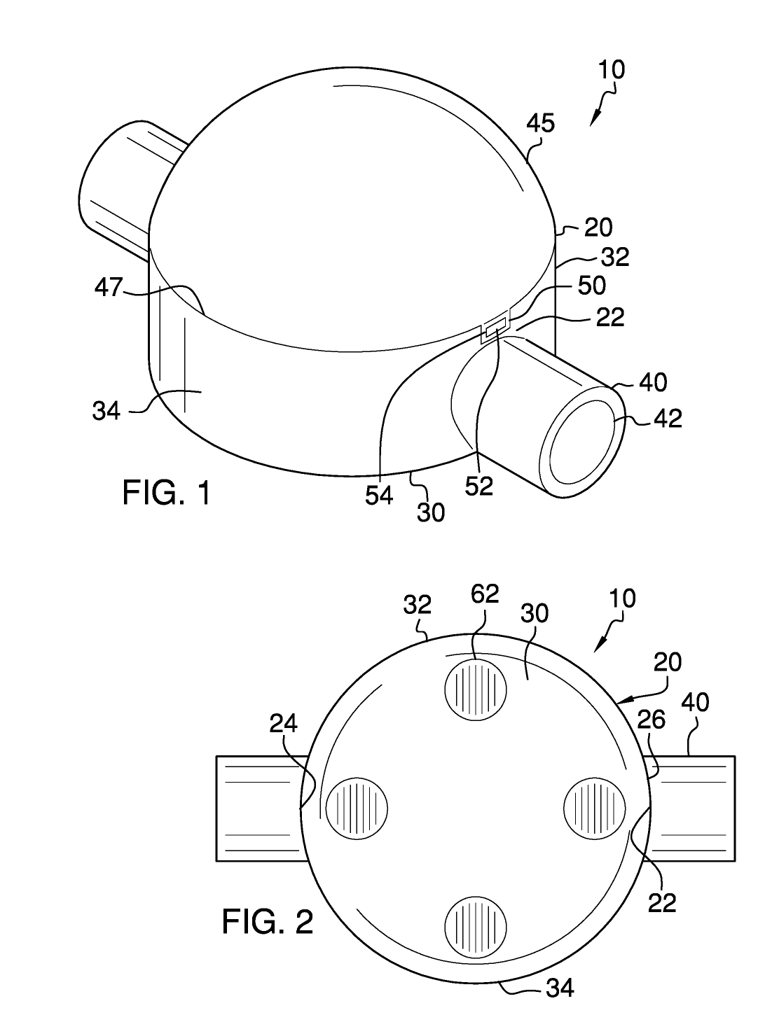

FIG. 1 is an isometric view with a lid in a closed condition.

FIG. 2 is a bottom plan view.

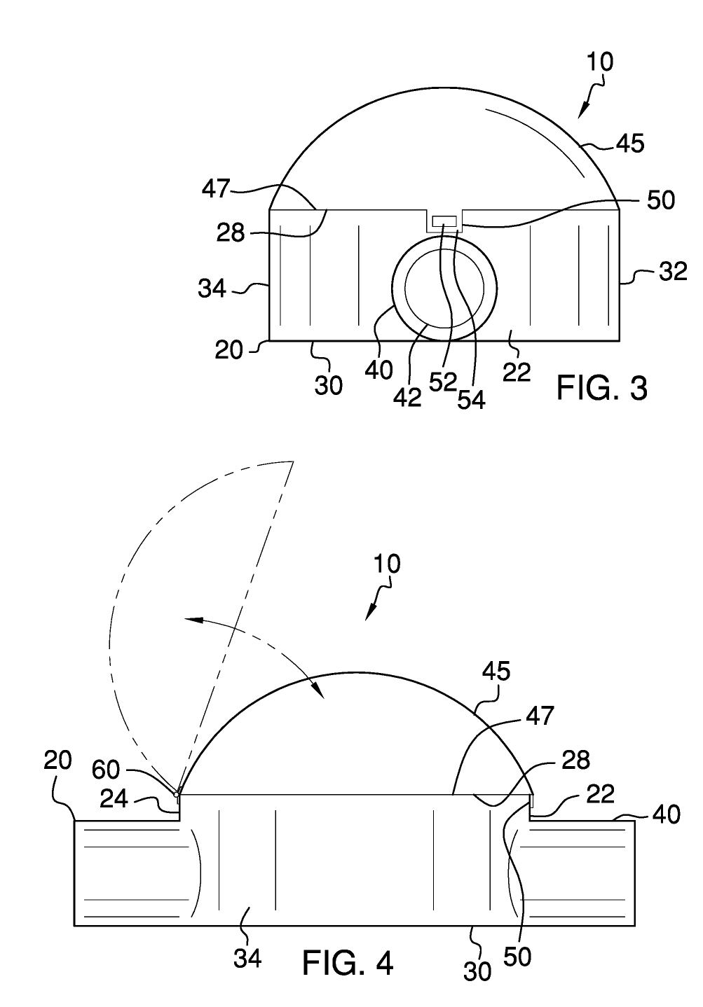

FIG. 3 is a front elevation view.

FIG. 4 is a side elevation view.

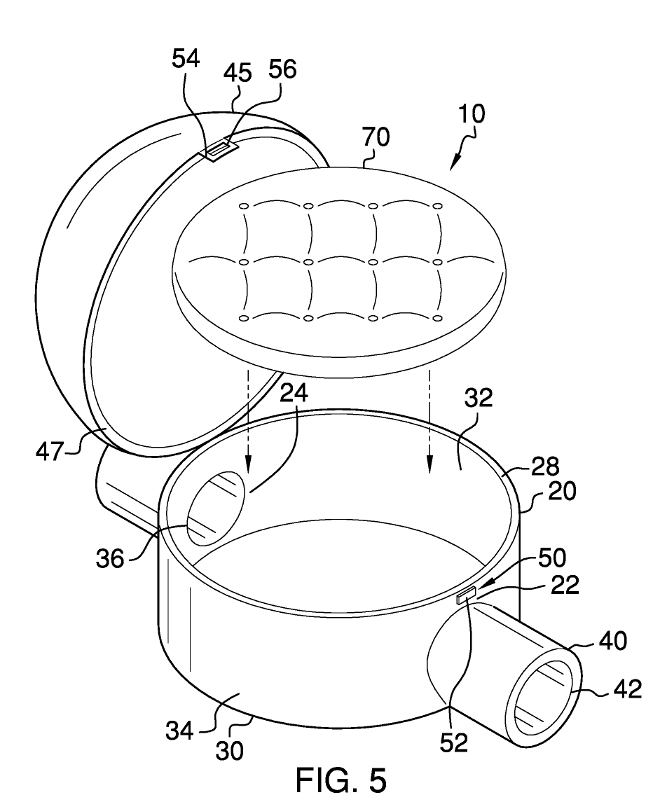

FIG. 5 is an exploded isometric view showing the lid in an open condition with an insertable bed.

### DETAILED DESCRIPTION OF THE DRAWINGS

With reference now to the drawings, and in particular FIGS. 1 through 5 thereof, an example of the instant pet crawl-in den employing the principles and concepts of the present pet crawl-in den and generally designated by the reference number 10 will be described.

Referring to FIGS. 1 through 5, the present pet crawl-in den 10 is illustrated. The pet crawl-in den 10 includes a waterproof igloo shelter body 20. The igloo shelter body 20 includes an annular housing 22. The annular housing 22 has a front side 24, a rear side 26, a top edge 28, a bottom surface 30, a right side 32, and a left side 34. An aperture 36 is disposed through each of the front side 24 and the rear side 26. The igloo shelter body 20 also includes a pair of hollow cylindrical access members 40. One of the access members 40 is perpendicularly disposed on each of the front side 24 and the rear side 26 in direct alignment with a respective one of the apertures 36. Each of the access members 36 has a conduit 42 in fluid communication with the respective aperture 36. The pair of access members 36 provides a pet, such as a cat or a dog, not only entry and exit route from either the front side 24 or the rear side 26, but also an escape route if attacked or in the event of a fire through either the front side 24 or the rear side 26.

A lid 45 is hingedly disposed atop the top edge 28 of the annular housing 22. The lid 45 has a lower edge 47 alignable with the entire top edge 28 of the housing 22 and is latchable to the housing 22. The lid 45 is preferably a dome. A latch 50 is provided to latch the lid 45 to the housing 22. The latch 50 has a protrusion 52 centrally disposed on the front side 24 in a position between the respective access member and the top edge 28 of the annular housing 22 and a frame 54 disposed on the lower edge 47 of the lid 45. The frame 54 has a central opening 56. The protrusion 52 and the central opening 56 are engageable to each other. The protrusion 52 is parallelepiped, while the central opening 56 is rectangular to accommodate the engagement of the protrusion 52. A hinge 60 is disposed on the housing 22 and the lid on the rear side 26 opposite the latch 50.

A plurality of disc-shaped footing bodies 62 is disposed on the bottom surface 30 of the annular housing 22. Each footing body 62 has a gripping surface 64 to prevent the housing 22 from sliding across a slick surface.

A washable disc-shaped cushioned bed 70 is removably disposed within the annular housing 22 for the comfort of a pet resting within the annular housing 22. Because the bed 70 is removably disposed within the annular housing 22, the bed 70 is removable for washing to maintain the bed 70 in a clean and sanitary condition.

Each of the aperture 36 and the conduit 42 of each of the access members 40 has a same diameter which is in a range of six inches to forty-eight inches to accommodate entry and exit of pets in a wide range of sizes.

What is claimed is:

1. A pet crawl-in den comprising:
an igloo shelter body comprising:
an annular housing having a front side, a rear side, a top edge, a bottom surface, a right side, and a left side;
an aperture disposed through each of the front side and the rear side;
a pair of hollow cylindrical access members, one of the access members perpendicularly disposed on each of the front side and the rear side in direct alignment with a respective one of the apertures, each of the access members having a conduit in fluid communication with the respective aperture, the conduit having a same diameter as the respective aperture; and
a lid disposed atop the top edge of the annular housing, the lid having a lower edge alignable with the entire top edge of the annular housing.

2. The pet crawl-in den of claim 1 wherein the lid is latchable to the annular housing.

3. The pet crawl-in den of claim 1 comprising:
a plurality of footing bodies disposed on the bottom surface of the annular housing, each footing body having a gripping surface.

4. The pet crawl-in den of claim 1 wherein the lid is hingedly attached to the annular housing.

5. The pet crawl-in den of claim 1 wherein the lid is a dome.

6. The pet crawl-in den of claim 1 wherein the igloo shelter body is waterproof.

7. The pet crawl-in den of claim 1 wherein the diameter of each of the aperture and the conduit of each of the access members is in a range of six inches to forty-eight inches.

8. The pet crawl-in den of claim 2 comprising:
a latch having a protrusion centrally disposed on the front side in a position between the respective access member and the top edge of the annular housing and a frame disposed on the lower edge of the lid, the frame having a central opening, wherein the protrusion and the central opening are engageable to each other.

9. The pet crawl-in den of claim 8 comprising a hinge disposed on the annular housing and the lid on the rear side opposite the latch.

10. A pet crawl-in den comprising:
a waterproof igloo shelter body comprising:
an annular housing having a front side, a rear side, a top edge, a bottom surface, a right side, and a left side;
an aperture disposed through each of the front side and the rear side;
a pair of hollow cylindrical access members, one of the access members perpendicularly disposed on each of the front side and the rear side in direct alignment with a respective one of the apertures, each of the access members having a conduit in fluid communication with the respective aperture, the conduit having a same diameter as the respective aperture;
a lid hingedly disposed atop the top edge of the annular housing, the lid having a lower edge alignable with the entire top edge of the annular housing, the lid being latchable to the housing, wherein the lid is a dome;
a latch having a protrusion centrally disposed on the front side in a position between the respective access member and the top edge of the annular housing and a frame disposed on the lower edge of the lid, the frame having a central opening, wherein the protrusion and the central opening are engageable to each other;
a hinge disposed on the annular housing and the lid on the rear side opposite the latch;
a plurality of disc-shaped footing bodies disposed on the bottom surface of the annular housing, each footing body having a gripping surface; and
a washable disc-shaped cushioned bed removably disposed within the annular housing.

11. The pet crawl-in den of claim 10 wherein the diameter of each of the aperture and the conduit of each of the access members is in a range of six inches to forty-eight inches.
